(19) United States
(12) Patent Application Publication
(10) Pub. No.: US 2007/0136063 A1
(43) Pub. Date: Jun. 14, 2007

(54) Adaptive nametag training with exogenous inputs

(75) Inventors: Timothy J. Grost, Clarkston, MI (US); Elizabeth Chesnutt, Troy, MI (US); Uma Arun, Novi, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: General Motors Corporation

(21) Appl. No.: 11/299,806

(22) Filed: Dec. 12, 2005

(51) Int. Cl. G10L 15/04

(52) U.S. Cl. 704/254

(57) ABSTRACT

A method of speech recognition includes receiving an utterance at a vehicle telematics unit. The utterance is converted into at least one phoneme. A confidence score is determined based on a comparison between the at least one phoneme and a nametag phoneme. The at least one phoneme is stored in association with the nametag phoneme based on the confidence score.

### FIELD OF THE INVENTION

This invention relates generally to data transmissions over a wireless communication system. Moreover, the invention relates to a strategy for automatic speech recognition.

### BACKGROUND OF THE INVENTION

The implementation of an effective and efficient strategy for users to interface with electronic devices is a significant consideration of system designers and manufacturers. Automatic speech recognition (ASR) is one promising technique that allows a user to effectively communicate with selected electronic devices, such as digital computer systems. Speech typically consists of one or more spoken utterances which each may include a single word or a series of closely-spaced words forming a phrase or a sentence.

An automatic speech recognizer typically builds a comparison database for performing speech recognition when a potential user “trains” the recognizer (e.g., a computer software program) by providing a set of sample speech. Speech recognizers tend to significantly fail in performance when a mismatch exists between training conditions and actual operating conditions. Such a mismatch may arise from various sources of extraneous sounds. For example, in an automobile, noise from a fan blower, engine, traffic, an open window or other internal or external noise condition may create difficulties with speech recognition in the presence of such ambient noises.

A nametag for an ASR application is an alias for a particular speaker annunciation, spoken, recorded, and understood by the ASR application.

A method that has been previously implemented for nametag recognition is template matching. Template matching typically involves analyzing an entire utterance (i.e., a string of sounds produced by a speaker between two pauses) at once and attempts to match it to a stored nametag. One shortcoming of template matching relates to how the ASR application tends to fail matching the utterance to its appropriate nametag in a noisy environment. Another shortcoming of template matching is that it requires a relatively large storage capacity and/or memory for storing of the nametags.

It is an object of this invention, therefore, to provide a strategy for providing a more robust ASR application that is capable of recognizing nametags in relatively quiet and noisy environments, and to overcome the deficiencies and obstacles described above.

### SUMMARY OF THE INVENTION

One aspect of the invention provides a method of speech recognition. The method includes receiving an utterance at a vehicle telematics unit. The method includes receiving an utterance and converting the utterance into at least one phoneme. A confidence score is determined based on a comparison between the at least one phoneme and a nametag. The utterance is stored based on the confidence score.

Another aspect of the invention provides a computer usable medium including a program for speech recognition. The medium includes computer readable program code for receiving an utterance at a vehicle telematics unit, and computer readable program code for converting the utterance into at least one phoneme. The medium further includes computer readable program code for determining a confidence score based on a comparison between the at least one phoneme and a nametag, and computer readable program code for storing the utterance based on the confidence score.

Another aspect of the invention provides a speech recognition system. The system includes means for receiving an utterance at a vehicle telematics unit, and means for converting the utterance into at least one phoneme. The system further includes means for determining a confidence score based on a comparison between the at least one phoneme and a nametag, and means for storing the utterance based on the confidence score.

The aforementioned and other features and advantages of the invention will become further apparent from the following detailed description of the presently preferred examples, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 illustrates a system for adaptive nametag training with exogenous inputs, in accordance with one example of the present invention;

FIGS. 2A and 2B illustrate a flowchart of adaptive nametag training with exogenous inputs, in accordance with one example of the present invention.

### DETAILED DESCRIPTION OF THE PRESENTLY PREFERRED EXEMPLARY EMBODIMENTS

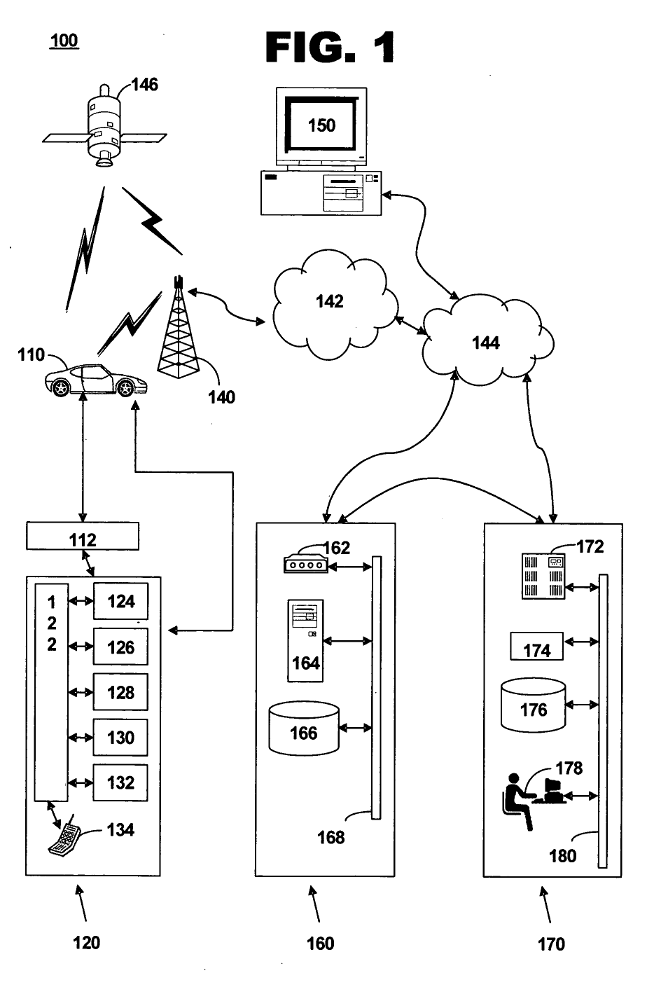

FIG. 1 illustrates a system for adaptive nametag training with exogenous inputs, in accordance with one example of the present invention and shown generally by numeral 100. Mobile vehicle communication system (MVCS) 100 includes a mobile vehicle communication unit (MVCU) 110, a vehicle communication network 112, a telematics unit 120, one or more wireless carrier systems 140, one or more communication networks 142, one or more land networks 144, one or more satellite broadcast systems 146, one or more client, personal or user computers 150, one or more web-hosting portals 160, and one or more call centers 170. In one example, MVCU 110 is implemented as a mobile vehicle equipped with suitable hardware and software for transmitting and receiving voice and data communications. MVCS 100 may include additional components not relevant to the present discussion. Mobile vehicle communication systems and telematics units are known in the art.

A mobile vehicle communication system (MVCS) 100 includes a mobile vehicle communication unit (MVCU) 110, a vehicle communication network 112, a telematics unit 120, one or more wireless carrier systems 140, one or more communication networks 142, one or more land networks 144, one or more satellite broadcast systems 146, one or more client, personal or user computers 150, one or more web-hosting portals 160, and one or more call centers 170. In one example, MVCU 110 is implemented as a mobile vehicle equipped with suitable hardware and software for transmitting and receiving voice and data communications. MVCS 100 may include additional components not relevant to the present discussion. Mobile vehicle communication systems and telematics units are known in the art.

MVCU 110 is also referred to as a mobile vehicle in the discussion below. In operation, MVCU 110 is implemented as a motor vehicle, a marine vehicle, or as an aircraft, in various examples. MVCU 110 may include additional components not relevant to the present discussion.

Vehicle communication network 112 sends signals to various units of equipment and systems within vehicle 110 to perform various functions such as monitoring the operational state of vehicle systems, collecting and storing data from the vehicle systems, providing instructions, data and programs to various vehicle systems, and calling from telematics unit 120. In facilitating interactions among the various communication and electronic modules, vehicle communication network 112 utilizes interfaces such as controller-area network (CAN), Media Oriented System Transport (MOST), Local Interconnect Network (LIN), Ethernet (10 base T, 100 base T), International Organization for Standardization (ISO) Standard 9141, ISO Standard 11898 for high-speed applications, ISO Standard 11519 for lower speed applications, and Society of Automotive Engineers (SAE) standard J1850 for higher and lower speed applications. In one example, vehicle communication network 112 is a direct connection between connected devices.

Telematics unit 120 sends to and receives radio transmissions from wireless carrier system 140. Wireless carrier system 140 is implemented as any suitable system for transmitting a signal from MVCU 110 to communication network 142.

Telematics unit 120 includes a processor 122 connected to a wireless modem 124, a global positioning system (GPS) unit 126, an in-vehicle memory 128, a microphone 130, one or more speakers 132, and an embedded or in-vehicle mobile phone 134. In other examples, telematics unit 120 is implemented without one or more of the above listed components such as, for example, speakers 132. Telematics unit 120 may include additional components not relevant to the present discussion.

In one example, processor 122 is implemented as a microcontroller, controller, host processor, or vehicle communications processor. In one example, processor 122 is a digital signal processor. In an example, processor 122 is implemented as an application specific integrated circuit (ASIC). In another example, processor 122 is implemented as a processor working in conjunction with a central processing unit (CPU) performing the function of a general purpose processor. GPS unit 126 provides latitudinal and longitudinal coordinates of the vehicle responsive to a GPS broadcast signal received from one or more GPS satellite broadcast systems (not shown). In-vehicle mobile phone 134 is a cellular-type phone such as, for example a digital, dual-mode (e.g., analog and digital), dual-band, multi-mode or multi-band cellular phone.

Processor 122 executes various computer programs that control programming and operational modes of electronic and mechanical systems within MVCU 110. Processor 122 controls communications (e.g., call signals) between telematics unit 120, wireless carrier system 140, and call center 170. Additionally, processor 122 controls reception of communications from satellite broadcast system 146. In one example, automatic voice recognition (ASR) application is installed in processor 122 that can translate human voice input through microphone 130 to digital signals. Processor 122 generates and accepts digital signals transmitted between telematics unit 120 and a vehicle communication network 112 that is connected to various electronic modules in the vehicle. In one example, these digital signals activate the programming mode and operation modes, as well as provide for data transfers such as, for example, data over voice channel communication. In this example, signals from processor 122 are translated into voice messages and sent out through speaker 132.

Wireless carrier system 140 is a wireless communications carrier or a mobile telephone system and transmits to and receives signals from one or more MVCU 110. Wireless carrier system 140 incorporates any type of telecommunications in which electromagnetic waves carry signal over part of or the entire communication path. In one example, wireless carrier system 140 is implemented as any type of broadcast communication in addition to satellite broadcast system 146. In another example, wireless carrier system 140 provides broadcast communication to satellite broadcast system 146 for download to MVCU 110. In an example, wireless carrier system 140 connects communication network 142 to land network 144 directly. In another example, wireless carrier system 140 connects communication network 142 to land network 144 indirectly via satellite broadcast system 146.

Satellite broadcast system 146 transmits radio signals to telematics unit 120 within MVCU 110. In one example, satellite broadcast system 146 may broadcast over a spectrum in the “S” band (2.3 GHz) that has been allocated by the U.S. Federal Communications Commission (FCC) for nationwide broadcasting of satellite-based Digital Audio Radio Service (DARS).

In operation, broadcast services provided by satellite broadcast system 146 are received by telematics unit 120 located within MVCU 110. In one example, broadcast services include various formatted programs based on a package subscription obtained by the user and managed by telematics unit 120. In another example, broadcast services include various formatted data packets based on a package subscription obtained by the user and managed by call center 170. In an example, digital map information data packets received by the telematics unit 120 from the call center 170 are implemented by processor 122 to determine a route correction.

Communication network 142 includes services from one or more mobile telephone switching offices and wireless networks. Communication network 142 connects wireless carrier system 140 to land network 144. Communication network 142 is implemented as any suitable system or collection of systems for connecting wireless carrier system 140 to MVCU 110 and land network 144.

Land network 144 connects communication network 142 to client computer 150, web-hosting portal 160, and call center 170. In one example, land network 144 is a public-switched telephone network (PSTN). In another example, land network 144 is implemented as an Internet protocol (IP) network. In other examples, land network 144 is implemented as a wired network, an optical network, a fiber network, other wireless networks, or any combination thereof. Land network 144 is connected to one or more landline telephones. Communication network 142 and land network 144 connect wireless carrier system 140 to web-hosting portal 160 and call center 170.

Client, personal, or user computer 150 includes a computer usable medium to execute Internet browser and Internet-access computer programs for sending and receiving data over land network 144 and, optionally, wired or wireless communication networks 142 to web-hosting portal 160. Computer 150 sends user preferences to web-hosting portal 160 through a web-page interface using communication standards such as hypertext transport protocol (HTTP), and transport-control protocol and Internet protocol (TCP/IP). In one example, the data includes directives to change certain programming and operational modes of electronic and mechanical systems within MVCU 110.

In operation, a client utilizes computer 150 to initiate setting or re-setting of user preferences for MVCU 110. In an example, a client utilizes computer 150 to provide radio station presets as user preferences for MVCU 110. User-preference data from client-side software is transmitted to server-side software of web-hosting portal 160. In an example, user-preference data is stored at web-hosting portal 160.

Web-hosting portal 160 includes one or more data modems 162, one or more web servers 164, one or more databases 166, and a network system 168. Web-hosting portal 160 is connected directly by wire to call center 170, or connected by phone lines to land network 144, which is connected to call center 170. In an example, web-hosting portal 160 is connected to call center 170 utilizing an IP network. In this example, both components, web-hosting portal 160 and call center 170, are connected to land network 144 utilizing the IP network. In another example, web-hosting portal 160 is connected to land network 144 by one or more data modems 162. Land network 144 sends digital data to and receives digital data from modem 162, data that are then transferred to web server 164. Modem 162 may reside inside web server 164. Land network 144 transmits data communications between web-hosting portal 160 and call center 170.

Web server 164 receives user-preference data from computer 150 via land network 144. In alternative examples, computer 150 includes a wireless modem to send data to web-hosting portal 160 through a wireless communication network 142 and a land network 144. Data is received by land network 144 and sent to one or more web servers 164. In one example, web server 164 is implemented as any suitable hardware and software capable of providing web server 164 services to help change and transmit personal preference settings from a client at computer 150 to telematics unit 120. Web server 164 sends to or receives from one or more databases 166 data transmissions via network system 168. Web server 164 includes computer applications and files for managing and storing personalization settings supplied by the client, such as door lock/unlock behavior, radio station preset selections, climate controls, custom button configurations, and theft alarm settings. For each client, the web server 164 potentially stores hundreds of preferences for wireless vehicle communication, networking, maintenance, and diagnostic services for a mobile vehicle. In another example, web server 164 further includes data for managing turn-by-turn navigational instructions.

In one example, one or more web servers 164 are networked via network system 168 to distribute user-preference data among its network components such as database 166. In an example, database 166 is a part of or a separate computer from web server 164. Web server 164 sends data transmissions with user preferences to call center 170 through land network 144.

Call center 170 is a location where many calls are received and serviced at the same time, or where many calls are sent at the same time. In one example, the call center is a telematics call center, facilitating communications to and from telematics unit 120. In another example, the call center is a voice call center, providing verbal communications between an advisor in the call center and a subscriber in a mobile vehicle. In yet another example, the call center contains each of these functions. In other examples, call center 170 and web server 164 and hosting portal 160 are located in the same or different facilities.

Call center 170 contains one or more voice and data switches 172, one or more communication services managers 174, one or more communication services databases 176, one or more communication services advisors 178, and one or more network systems 180.

Switch 172 of call center 170 connects to land network 144. Switch 172 transmits voice or data transmissions from call center 170, and receives voice or data transmissions from telematics unit 120 in MVCU 110 through wireless carrier system 140, communication network 142, and land network 144. Switch 172 receives data transmissions from and sends data transmissions to one or more web server 164 and hosting portals 160. Switch 172 receives data transmissions from or sends data transmissions to one or more communication services managers 174 via one or more network systems 180.

Communication services manager 174 is any suitable hardware and software capable of providing requested communication services to telematics unit 120 in MVCU 110. Communication services manager 174 sends to or receives from one or more communication services databases 176 data transmissions via network system 180. In one example, communication services manager 174 includes at least one digital and/or analog modem.

Communication services manager 174 sends to or receives from one or more communication services advisors 178 data transmissions via network system 180. Communication services database 176 sends to or receives from communication services advisor 178 data transmissions via network system 180. Communication services advisor 178 receives from or sends to switch 172 voice or data transmissions. Communication services manager 174 provides one or more of a variety of services including initiating data over voice channel wireless communication, enrollment services, navigation assistance, directory assistance, roadside assistance, business or residential assistance, information services assistance, emergency assistance, and communications assistance.

Communication services manager 174 receives service-preference requests for a variety of services from the client computer 150, web server 164, web-hosting portal 160, and land network 144. Communication services manager 174 transmits user-preference and other data such as, for example, primary diagnostic script to telematics unit 120 through wireless carrier system 140, communication network 142, land network 144, voice and data switch 172, and network system 180. Communication services manager 174 stores or retrieves data and information from communication services database 176. Communication services manager 174 may provide requested information to communication services advisor 178. In one example, communication services advisor 178 is implemented as a real advisor. In an example, a real advisor is a human being in verbal communication with a user or subscriber (e.g., a client) in MVCU 110 via telematics unit 120. In another example, communication services advisor 178 is implemented as a virtual advisor. In an example, a virtual advisor is implemented as a synthesized voice interface responding to service requests from telematics unit 120 in MVCU 110.

Communication services advisor 178 provides services to telematics unit 120 in MVCU 110. Services provided by communication services advisor 178 include enrollment services, navigation assistance, real-time traffic advisories, directory assistance, roadside assistance, business or residential assistance, information services assistance, emergency assistance, automated vehicle diagnostic function, and communications assistance. Communication services advisor 178 communicate with telematics unit 120 in MVCU 110 through wireless carrier system 140, communication network 142, and land network 144 using voice transmissions, or through communication services manager 174 and switch 172 using data transmissions. Switch 172 selects between voice transmissions and data transmissions.

In operation, an incoming call is routed to telematics unit 120 within mobile vehicle 110 from call center 170. In one example, the call is routed to telematics unit 120 from call center 170 via land network 144, communication network 142, and wireless carrier system 140. In another example, an outbound communication is routed to telematics unit 120 from call center 170 via land network 144, communication network 142, wireless carrier system 140, and satellite broadcast system 146. In this example, an inbound communication is routed to call center 170 from telematics unit 120 via wireless carrier system 140, communication network 142, and land network 144.

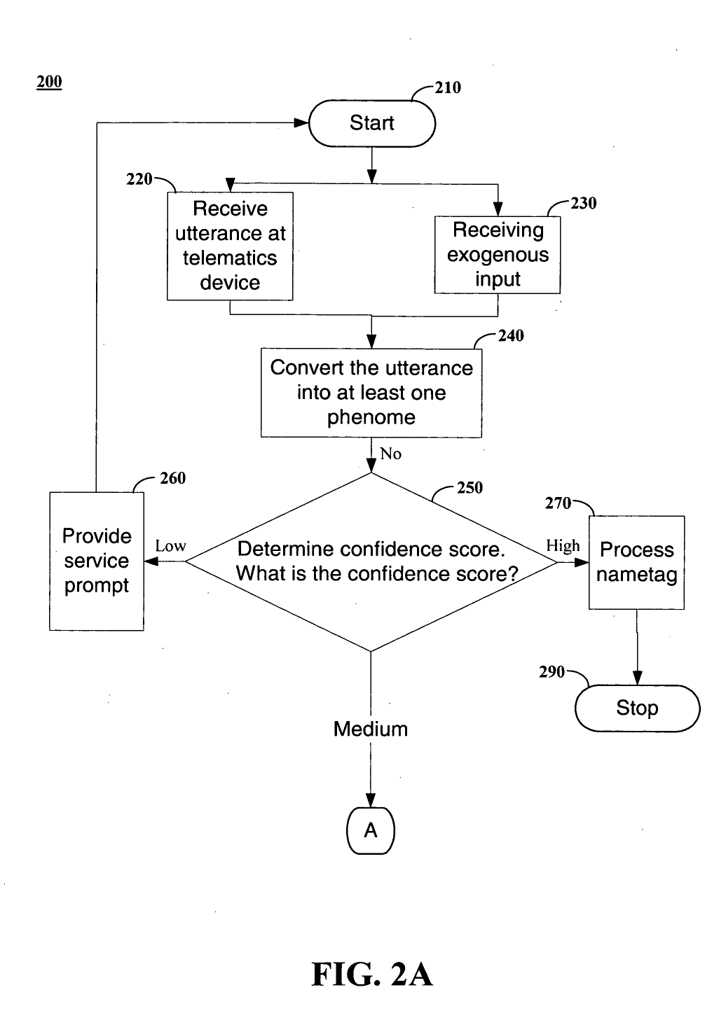

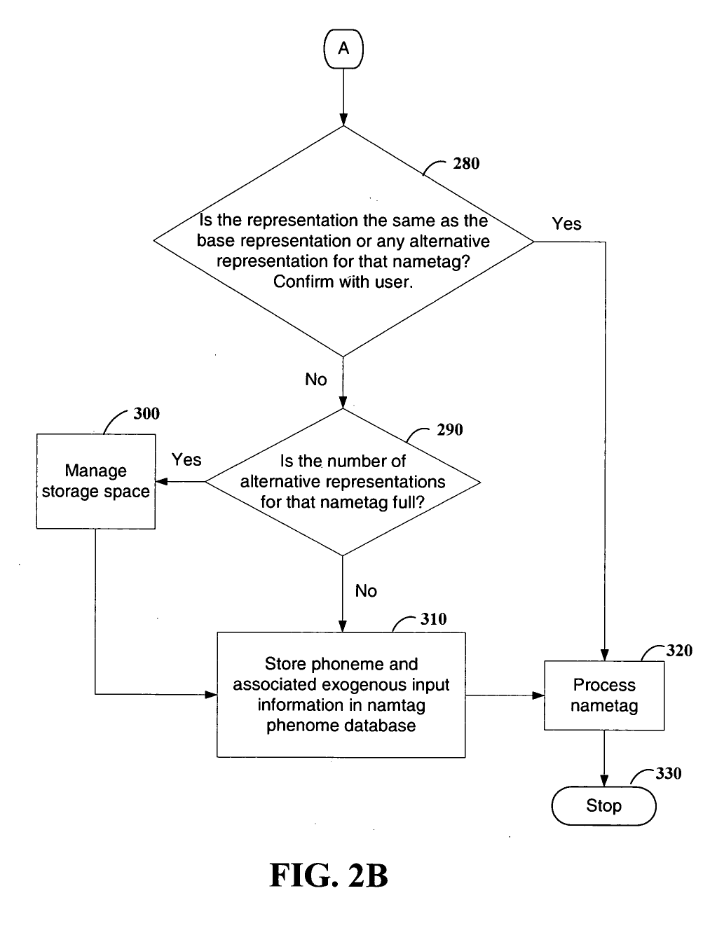

FIGS. 2A and 2B illustrate a flowchart of a method 200 for adaptive nametag training with exogenous inputs representative of one example of the present invention. Method 200 begins at 210. The present invention can take the form of a computer usable medium including a program for determining traffic information for a mobile vehicle in accordance with the present invention. The program, stored in the computer usable medium, includes computer program code for executing the method steps described and illustrated in FIGS. 2A and 2B. The program and/or portions thereof are, in various examples, are stored and executed by the MVCU 110, processor 122, databases 166, and web-hosting portal 160, call center 170, and associated (sub-)components as needed to operate the ASR application as well as other vehicle functions.

In the present application, an utterance is defined as a word, phrase, sentence, or command; a phoneme is defined as a single distinctive sound that, when several are put together, makes up a phonemic representation of an utterance, A nametag is data (e.g., a phone number, a name, a command, etc.) that includes one or more alternative utterances; a user's grammar is a collection of nametags; and ambient noise is noise or interference that can introduce errors in the conversion of an utterance into its proper phoneme(s). The nametag is, in one example, a speaker dependent phrase as initially uttered by a user and consequently stored for later utilization. This stored utterance is a base representation of the nametag. Ideally, a spoken utterance can be confidently matched to a given nametag to perform one or more functions in the vehicle.

At step 220, in one example, an utterance is received at the telematics unit 120. Specifically, the utterance is received by, for example, the microphone 130 and communicated to the processor 122 via the telematics unit 120. The microphone 130 can also pick up ambient noise, distortion, and other factors that can negatively affect the ASR application's ability to correctly match the utterance to a nametag. “Call Fred” is an example of an utterance.

At step 230, in one example, exogenous input is received at a vehicle telematics unit 120. In one example, the exogenous input is received simultaneously with the utterance. The exogenous input is received by sensors and communicated to the telematics unit 120 and to the processor 122. As used herein, exogenous input is information other than an audible signal indicative of known sources of audio interference. The exogenous input includes, but is not limited to vehicle speed, wiper frequency, window position, braking frequency, driver personalization, and heating and ventilations system (HVAC) settings. The exogenous input can affect how the utterance is interpreted in terms of ambient noise and acoustics. For example, ambient noise increases with vehicle speed, wiper frequency, lower window position (i.e., increased wind noise), increased braking frequency (i.e., increased traffic congestion), and HVAC setting (i.e., increased fan noise). Driver personalization relates to the positioning of the user within the cabin and is related to acoustics. Operation of each device associated with an exogenous input generates audible noise in the vicinity of the microphone, increasing ambient noise received by the microphone, and interfering with the speech recognition, complicating the interpretation of the utterance. Those skilled in the art will recognize that numerous exogenous input(s) can be received and are not limited to the examples provided herein.

At step 240, in one example, the utterance is converted into at least one phoneme. Once the utterance is received, a filter is applied to remove excessive ambient noise received by the microphone 130. In one example, the signal indicative of the exogenous input is also filtered. Noise filtration can be achieved via numerous noise cancellation algorithms known in the art (i.e., for removal of pops, clicks, white noise, and the like) and be performed by the processor 122 or by other means. Noise filtration increases the chances that the utterance will be converted into an appropriate phoneme and, thus, matched to its appropriate nametag via the ASR application.

At step 250, in one example, a confidence score is determined based on a comparison between the phoneme(s) and nametag phoneme(s) via an ASR contextualization process, which can be adapted for use with the present invention by one skilled in the art. Further, the ASR application uses the exogenous inputs for the contextualization process, especially when alternative phoneme representation exists for a given nametag. For example, when a number of alternative phoneme representations are available for a given nametag, the ASR application will attempt to match the current utterance and exogenous input to a nametag with similar exogenous inputs. This strategy allows the ASR application to overcome a portion of the ambient noise and, therefore, increase the chances of making a correct nametag match.

In one example, the exogenous inputs are used for nametag matching by examining a previous nametag having similar exogenous inputs. For example, if a user provides an utterance while the vehicle is traveling with the windshield wipers on, the ASR application takes this exogenous input into account in that wiper noise can distort the utterance in a certain manner. At a later time, if the same utterance is provided with the windshield wipers on, the ASR application would look to past nametags including windshield wipers as an exogenous input to determine a nametag match.

A determined confidence score that is lower than a perfect match but exceeds a first predetermined confidence score is termed a first confidence score, and is alternatively termed a high confidence score. A determined confidence score that is lower than the first predetermined confidence score but greater than a second predetermined confidence score is termed a second confidence score and is alternatively termed a medium confidence score. A determined confidence score that is lower than the second predetermined confidence score is termed a third confidence score and is alternatively termed a low confidence score. For example, a high confidence factor is a 90 percent match or greater, a low confidence factor is 40 percent match or less, and a medium match is between 40 and 90 percent. In other examples, possible confidence scores fall within more or less ranges, depending on the application, exogenous inputs, complexity of the application/environment, and the like.

At step 260, in one example, if the determined confidence score is a third confidence score, the result falls within the low confidence range. A prompt is then provided to the vehicle user to repeat the utterance. For example, an automated voice is provided over the speakers 132 that states “I am sorry, but your command was not understood. Could you please repeat that?” The method then reverts back to step 220.

At step 270, in one example, if the determined confidence score is a first confidence score, method 200 processes the nametag without further prompting from the vehicle user. For example, a matched phoneme-to-nametag involves dialing a phone number or issuing a command associated with the nametag (e.g., unlocking a door, rolling down a window, adjusting the cabin temperature, etc.). For example, when the user provided the utterance “Call Fred”, and subsequently received a high confidence score, the vehicle mobile phone 134 would dial a preprogrammed number corresponding to “Fred”. As another example, if a user uttered “unlock doors” and the ASR algorithm determined a high confidence score, the vehicle's doors would unlock automatically. Those skilled in the art will recognize that utterances can result in a variety of functions performed within the vehicle or remotely and are not limited to the examples provided herein. The method then terminates and/or be repeated as necessary.

At step 280, in one example, if the determined confidence score is a second confidence score, the ASR application determines if the phoneme(s) match any alternative stored phonemes for that nametag. If a match is produced, method 200 prompts the user to determine if the utterance matches the nametag and then proceeds to step 310. In one example, the exogenous input is determined or received based on the determination of a second confidence score. If no match is produced, the method continues to step 290.

At step 290, in one example, the ASR application determines if the storage space for the alternative representations for a given nametag is full, such as if the number of alternative representations exceeds a predetermined limit, or if the memory space occupied by those alternative representations is full. If there is a shortage of storage space, the method continues to step 300, otherwise it proceeds to step 310. The method for determining storage space availability varies on numerous factors and can be determined by one skilled in the art.

At step 300, in one example, storage space is managed. Specifically, storage space is allocated for the newest phoneme and exogenous input information. The storage is created by, for example, deleting the least used phoneme and exogenous information or the oldest accessed phoneme for a given nametag. Once a sufficient amount of storage space is created, the method proceeds to step 310. Those skilled in the art will recognize that numerous strategies can be utilized for managing storage space in accordance with the present invention.

At step 310, in one example, the newest phoneme and associated exogenous input and exogenous input information are written/stored in, for example, a database, such as database 166 and/or database 176. Advantageously, phonemes typically require much less storage space than templates. In one example, the newest phoneme associated exogenous input and exogenous input information are alternative representations of the base representation.

At step 320, the nametag is processed without further prompting from the vehicle user. For example, each stored phoneme may be linked to the nametag base representation by a set of pointers. Advantageously, this allows a pointer trail to be traversed from any newest phoneme associated exogenous input and exogenous input information data record to the nametag base representation. The method terminates and/or be repeated as necessary.

Those skilled in the art will recognize that the step order can be varied and is not limited to the order defined herein. In addition, step(s) can be eliminated, added, or modified In accordance with the present invention.

While the examples of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method of speech recognition comprising:
receiving an utterance at a vehicle telematics unit;
converting the utterance into at least one phoneme;
determining a confidence score based on a comparison between the at least one phoneme and a nametag phoneme; and
storing the at least one phoneme in association with the nametag phoneme based on the confidence score.

2. The method of claim 1 further comprising receiving exogenous input at the vehicle telematics unit.

3. The method of claim 2 wherein the exogenous input is selected from a group consisting of vehicle speed, wiper frequency, window position, braking frequency, driver personalization, and ventilation system settings.

4. The method of claim 2 wherein storing the at least one phoneme comprises storing the at least one phoneme in association with the nametag phoneme and exogenous input.

5. The method of claim 1 further comprising processing the nametag based on a third predetermined confidence range.

6. The method of claim 1 further comprising storing the at least one phoneme in association with the nametag based on a second predetermined confidence range.

7. The method of claim 1 further comprising determining storage space for alternative nametags.

8. The method of claim 8 further comprising managing storage space for the alternative nametags.

9. A computer usable medium including a program for speech recognition comprising:
computer readable program code for receiving an utterance at a vehicle telematics unit;
computer readable program code for converting the utterance into at least one phoneme;
computer readable program code for determining a confidence score based on a comparison between the at least one phoneme and a nametag phoneme; and
computer readable program code for storing the at least one phoneme in association with the nametag phoneme based on the determined confidence score.

10. The computer usable medium of claim 9 further comprising computer readable program code for receiving exogenous input at the vehicle telematics unit.

11. The computer usable medium of claim 10 wherein the exogenous input is selected from a group consisting of vehicle speed, wiper frequency, window position, braking frequency, driver personalization, and ventilation system settings.

12. The computer usable medium of claim 10 wherein computer readable program code for storing the at least one phoneme comprises computer readable program code for storing the at least one phoneme in association with the nametag phoneme and exogenous input

13. The computer usable medium of claim 9 further comprising computer readable program code for processing the nametag based on a third predetermined confidence range.

14. The computer usable medium of claim 9 further comprising computer readable program code for storing the at least one phoneme in association with the nametag based on a second predetermined confidence range.

15. The computer usable medium of claim 9 further comprising computer readable program code for determining storage space for alternative nametags.

16. The computer usable medium of claim 15 further comprising computer readable program code for managing storage space for the alternative nametags.

17. A speech recognition system comprising:
means for receiving an utterance at a vehicle telematics unit;
means for converting the utterance into at least one phoneme;
means for determining a confidence score based on a comparison between the at least one phoneme and a nametag phoneme; and
means for storing the at least one phoneme in association with the nametag phoneme based on the determined confidence score.
